(19) United States
(12) Patent Application Publication
(10) Pub. No.: US 2010/0114898 A1
(43) Pub. Date: May 6, 2010

(54) PUBLICATION SERVICES

(75) Inventors: Brian J. Wasserman, Escondido, CA (US); Thomas K. Ryan, Valley Center, CA (US); George R. Hood, Poway, CA (US); Neelesh Bansode, Bangalore (IN); Shashank Shekhar, Patna (IN); Steven Eggerman, Poway, CA (US); Yabing Bi, San Diego, CA (US)

Correspondence Address: JAMES M. STOVER;TERADATA CORPORATION, 2835 MIAMI VILLAGE DRIVE, MIAMISBURG, OH, 45342, US

(73) Assignee: TERADATA US, INC., Miamisburg, OH (US)

(21) Appl. No.: 12/574,528

(22) Filed: Oct. 6, 2009

Related U.S. Application Data
(60) Provisional application No. 61/195,254, filed on Oct. 6, 2008.

(51) Int. Cl. G06F 17/30

(52) U.S. Cl. 707/741; 707/802; 707/E17.005; 707/E17.045; 707/E17.002

(57) ABSTRACT

An apparatus, method, and article of manufacture provide the ability to publish information to an external source as part of an integrated workflow in a computer system. The computer system executes a relational database management system (RDBMS). A publication services processing engine utilizes the RDBMS to publish the information based on a publication node. A publication object defines a collection of information that is published to the external source. A publication action defines a specification of a manner in which the information in the publication object is to be published to the external source. The publication node defines a workflow data process that specifies the publication object and the publication action.

### TO RELATED APPLICATIONS

This application claims the benefit under 35 U.S.C. Section 119(e) of the following co-pending and commonly-assigned U.S. provisional patent application(s), which is/are incorporated by reference herein:

Provisional Application Ser. No. 61/195,254, filed Oct. 6, 2008, by Brian J. Wasserman, Thomas K. Ryan, George Robert Hood, Neelesh Bansode, Shashank Shekhar, Steve Eggerman, and Yabing Bi, entitled “Publication Services,” attorneys' docket number 13923 (30145.464-US-U1).

### BACKGROUND OF THE INVENTION

1. Field of the Invention

This invention relates in general to managing business critical data in a computer, and in particular, to publishing or managing the outbound usage of such data.

2. Description of Related Art

Master Data Management™, available from the assignee of the present invention, is an application that allows users to manage their business critical data. This critical data can originate from a myriad of sources and external feeds, but ultimately, the goal is that all of this data be consolidated into a central business data warehouse. Master Data Management™ is the process and framework for maintaining a series of business rules and process workflows that will manage this data as it feeds in from multiple sources. Master Data Management™ then applies these business rules and process workflows to produce “master” data, which is then fed to all consuming business processes.

Core to the management of master data is the definition of a data model. The data model serves as the foundation for all business rules and workflow processes within the Master Data Management™ (MDM) framework. The data model represents the form the master data must ultimately take in the customer's data warehouse to be used by the consuming business applications.

Part of Master Data Management is also the management of the outbound usage of this Master Data. It is desirable to integrate the downstream usage of master data directly into a MDM Framework. In this regard, the prior art fails to provide a centralized process or facility for managing how master data is used. The prior art further fails to provide a centralized process for pushing data to external sources as part of an integrated workflow.

What is needed is the ability to extend a workflow process to facilitate the outbound function of the data to consuming processes and applications while providing a centralized process and facility for managing how master data is used.

### SUMMARY OF THE INVENTION

Embodiments of the invention provide the ability to publish information from a structured (e.g., relational) database management system (RDBMS) to an external source as part of an integrated workflow (e.g., by utilizing a new workflow data process). To utilize the power, scalability, and parallelism of an RDBMS, as much of the processing as possible is preformed by the RDBMS to optimize the processing engine.

As a new and distinct node type within a workflow (i.e., a data process), a Publication Node provides a quick and easy means for users to identify a set of data (i.e., the Publication Object) to be published, to specify the manner in which the data will be published (i.e., the Publication Action), and specify any additional Audit parameters.

Further, a publication services processing engine may be used to facilitate the outbound function of the data to consuming processes and applications.

### BRIEF DESCRIPTION OF THE DRAWINGS

Referring now to the drawings in which like reference numbers represent corresponding parts throughout:

FIG. 1 illustrates an exemplary hardware and software environment according to the preferred embodiment of the present invention;

FIG. 2 illustrates the structure for how Publishing Services are integrated into a framework in accordance with one or more embodiments of the invention;

FIG. 3 illustrates publication processing with audit capabilities in accordance with one or more embodiments of the invention;

FIG. 4 is a diagram illustrating the processing of publication requests to non-database sources in accordance with one or more embodiments of the invention; and

FIG. 5 is a flow chart illustrating the logical flow for publishing information to an external source as part of an integrated workflow in accordance with one or more embodiments of the invention.

### DETAILED DESCRIPTION OF THE PREFERRED EMBODIMENT

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

Overview

One or more embodiments of the invention provide a framework for managing the publication of master data to consuming applications, processes, or users.

In a Master Data Management (MDM) Framework, all the master data is accessed only by MDM sanctioned data processes, also called “workflows”. These workflows are central to the concept of having master data, as they become the only means by which the underlying core data can be modified. Essentially, all inbound data passes through one or more workflows that can perform the following actions on the inbound data:
Perform data quality checks;
Perform data validation;
Perform data transformations (or cleanup of data);
Identify errors in the underlying data and notify the data steward of these issues; and
Migrate data into the Master or “Gold” copy of the data, where it resides in a protected manner.

Accordingly, current MDM workflows govern the flow of inbound data. Publishing services (provided by one or more embodiments of the invention) is an extension of the workflow process to facilitate the outbound function of the data to consuming processes and applications. A new type of workflow node—called a “Publication” node—is used to push MDM-managed data to consumer applications and processes.

Through publishing services, customers can use workflows to publish data. Data can be published for a variety of reasons:
Error records can be published directly to a data steward as part of a data quality workflow;
New records can be pushed to consuming applications; and
Critical updates to the master data can be published to consuming applications.

To support the publishing services framework, several new conceptual objects may be defined by embodiments of the invention. These include:
Publication Object;
Publication Action; and
Publication Node (integrated into Workflows).

Hardware and Software Environment Overview

Master data (sometimes referred to as reference data) are facts that define a business entity, facts that may be used to model one or more definitions or view of an entity. Entity definitions based on master data provide business consistency and data integrity when multiple systems across an organization (or beyond) identify the same entity differently (e.g., in differing data models).

Business entities modeled via master data are usually customer, product, or finance. However, master data can define any entity, like employee, supplier, location, asset, claim, policy, patient, citizen, chart of accounts, etc.

A system of record is often created or selected (also referred to as a trusted source) as a central, authenticated master copy from which entity definitions (and physical data) are propagated among all systems integrated via a Master Data Management™ (MDM) framework 100.

The system of record can take many forms. Many users build a central database (e.g.

a data warehouse or operational data store) as a hub through which master data, metadata, and physical data are synchronized. Some hubs are simply master files or tables that collect and collate records.

Regardless of the technology approach, embodiments of the invention provide the ability to deploy a system on any designated target system for testing or production.

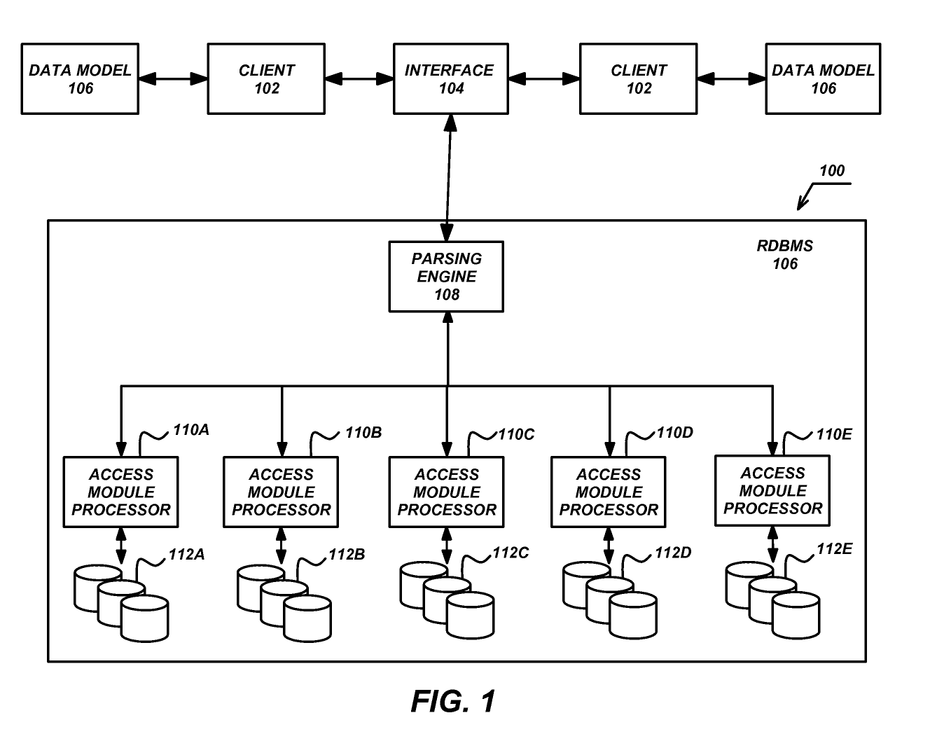

FIG. 1 illustrates an exemplary hardware and software environment according to the preferred embodiment of the present invention. In the exemplary environment, a computer system 100 implements an improved MDM framework 100, in a three-tier client-server architecture, wherein the first or client tier provides clients 102 that may include, inter alia, a graphical user interface (GUI), the second or middle tier provides an interface 104 for performing functions and interfacing with a central database or data warehouse as described later in this application, and the third or server tier comprises the central database or data warehouse (also referred to as a Relational DataBase Management System (RDBMS) 106) that stores data and metadata in a relational database. Such an RDBMS 106 is utilized to store the master data and provide a standard format within framework 100 for the master data. The first, second, and third tiers may be implemented in separate machines, or may be implemented as separate or related processes in a single machine.

In the preferred embodiment, the RDBMS 106 includes at least one parsing engine (PE) 108 and one or more access module processors (AMPs) 110A-110E storing the relational database in one or more data storage devices 112A-112E. The parsing engine 108 and access module processors 110 may be implemented in separate machines, or may be implemented as separate or related processes in a single machine. The RDBMS 106 used in the preferred embodiment comprises the Teradata® RDBMS sold by Teradata™ US, Inc., the assignee of the present invention, although other DBMS's could be used. In this regard, Teradata® RDBMS is a hardware and software based data warehousing and analytic application/database system.

Generally, clients 102 include a graphical user interface (GUI) for operators or users of the system 100, wherein requests are transmitted to the interface 104 to access data stored in the RDBMS 106, and responses are received therefrom. In response to the requests, the interface 104 performs the functions described below, including formulating queries for the

RDBMS 106 and processing data retrieved from the RDBMS 106. Moreover, the results from the functions performed by the interface 104 may be provided directly to clients 102 or may be provided to the RDBMS 106 for storing into the relational database. Once stored in the relational database, the results from the functions performed by the interface 104 may be retrieved more expeditiously from the RDBMS 106 via the interface 104. Further, each client 102 may have other data models 106.

Note that clients 102, interface 104, and RDBMS 106 may be implemented in separate machines, or may be implemented as separate or related processes in a single machine. Moreover, in one or more embodiments, the system 100 may use any number of different parallelism mechanisms to take advantage of the parallelism offered by the multiple tier architecture, the client-server structure of the client 102, interface 104, and RDBMS 106, and the multiple access module processors 110 of the RDBMS 106. Further, data within the relational database may be partitioned across multiple data storage devices 112 to provide additional parallelism.

Generally, the clients 102, interface 104, RDBMS 106, parsing engine 108, and/or access module processors 110A-110E comprise logic and/or data tangibly embodied in and/or accessible from a device, media, carrier, or signal, such as RAM, ROM, one or more of the data storage devices 112A-112E, and/or a remote system or device communicating with the computer system 100 via one or more data communications devices. The above elements 102-112 and/or operating instructions may also be tangibly embodied in memory and/or data communications devices, thereby making a computer program product or article of manufacture according to the invention. As such, the terms “article of manufacture,” “program storage device” and “computer program product” as used herein are intended to encompass a computer program accessible from any computer readable device or media. Accordingly, such articles of manufacture are readable by a computer and embody at least one program of instructions executable by a computer to perform various method steps of the invention.

However, those skilled in the art will recognize that the exemplary environment illustrated in FIG. 1 is not intended to limit the present invention. Indeed, those skilled in the art will recognize that other alternative environments may be used without departing from the scope of the present invention. In addition, it should be understood that the present invention may also apply to components other than those disclosed herein.

Hardware and software Environment Details

As described above with respect to FIG. 1, the master data is stored in RDBMS 106 and is accessed by clients 102 via interface 104. Such client 102 access through interface 104 is enabled by MDM sanctioned data processes referred to as workflows (e.g., provided in interface 104). Rather than being provided via interface 104, such workflows may be provided as part of parsing engine 108 or be provided by the AMPs 110 (or other parts of RDBMS 106). Consumer applications and processes may execute on clients 102 and may need to receive data from the RDBMS 106. Embodiments of the invention provide a workflow node referred to as a publication node that pushes MDM-managed data (e.g., from within RDBMS 106) to consumer applications and processes on clients 102.

Accordingly, embodiments of the invention extend the workflow process to include not just management of the data, but also the usage of that data by external consuming processes and applications (i.e., the outbound usage of master data). Specifically, this is the ability of the MDM framework to push data into different formats that can be consumed by downstream applications. Without this innovation, the usage of the master data would continue to be a disjointed process, implemented by several different teams throughout the enterprise system. Publication centralizes the management and provides a consistent means for moving data to downstream applications, so that they can be integrated with the rest of the enterprise applications. To provide such a publication of data (i.e., to support a publishing services framework), various entities may be needed including a Publication Object, Publication Action and Publication Node. Further, a publication services processing engine may be used to facilitate the outbound function of the data to consuming processes and applications.

Publication Object

A Publication Object is defined as any collection of information that can be published to a downstream application, process, or end user (e.g., client 102). In other words, the Publication Object is the specification of the data that will be pushed to consuming applications and processes in metadata format, and the linkage of this specification to a business context. Thus, a Publication Object provides a business context for end users that they can use to move data to consuming applications and processes. This allows business users to leverage this data without requiring them to know the underlying data structure. Without the Publication Object, users would have to manually specify data requirements down to the database Table and Column level each and every time they wanted to push data to a consuming process.

Publication Objects can be broken down into four areas:
Design Time component, in which users define a publication object;
Class definitions of a publication object;
Deployment of publication objects from XML into the Database; and
Metadata representation of the publication object—both in the database (DDL) and in its XML representation.

Accordingly, one may note that a Publication Object is comprised of a Publication

Key (as part of the class definition), and the Publication Metadata. In the context of publishing master data, the Publication Metadata specifies the composition of the data (tables and columns) that will be published to the downstream consuming application, process, or user. In the context of publishing master data, the Publication Metadata specifies the composition of the data (tables and columns) that will be published to the downstream consuming application, process or user. In the context of Teradata™ MDM, Publication Metadata is represented by one or more XDocuments (i.e., an XML based document), and their respective properties. XDocuments and properties are used by Teradata™ MDM processes to denote underlying tables and columns within RDBMS 106 respectively. The Publication Key is used to create a singular reference to this collection of data.

It should also be noted that a Publication Object can be referenced directly in a workflow node through its Publication Key. For example, referring to a “Customer” Key will result in publishing all of the underlying data structures that have been mapped to “Customer”.

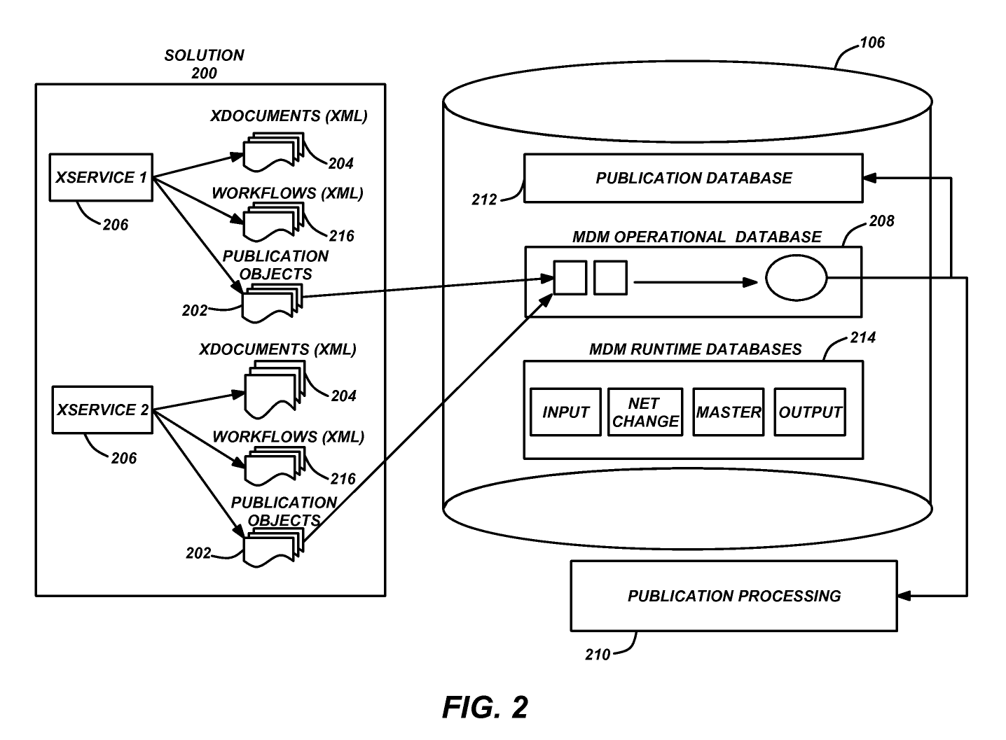

FIG. 2 illustrates the structure for how Publishing Services are integrated into the framework 100 in accordance with one or more embodiments of the invention. As illustrated, Publication Objects 202 are defined in the context of an XService 206. Accordingly, each XService 206 will contain its own list of Publication Objects 202 (which could result in duplication of defined Publication Objects 202).

Publication Object 202 metadata is stored in two locations. At design time,

Publication Object 202 metadata is stored locally in XML files. However, as the Solution 200 is deployed to the runtime environment, the Publication Object 202 metadata is moved into the operational database 208.

In view of the above, it can be seen that Publication Objects convert a cumbersome process of identifying data—something that can only be done by an expert data architect—into a business-user-friendly process of identifying a business object and matching it to a consuming application or process.

Publication Action

The Publication Action is defined as the manner in which the data will be published. In other words, the publication action is the specification of the method by which the data will be published and the specification of the format in which it will be published. Publication Actions allow the user to specify exactly how a specific set of data will be pushed to a consuming application or process. There are a variety of mechanisms for actually publishing data to another application, process, or to an end user. These actions include:
Publishing data to Excel™ Spreadsheet Format and distributing in file or email form;
Publishing data to a text file, in Comma-Separated-Value (CSV) format and distributing in file or email form, or pushing to another downstream application or process;
Publishing data to a separate set of Tables for consumption by a consuming application or process;
Publishing data to JMS (Java™ Message Service) Provider Queue Tables for consumption by a consuming application or process via JMS Messaging; and
Publishing data via an Email Notification (either alerting the user to data, or potentially emailing the data formatted into an Excel™ Spreadsheet or CSV text file).

Accordingly, the publication action allows users a means of distributing business critical master data to downstream applications and process by providing an easy means of specifying how the data should be published.

Publication Node

A Publication Node is a new processing node that can be inserted into an MDM workflow. The Publication Node is used to specify that data should be published when specific events occur. In other words, the publication node allows users to actively move data to consuming applications and processes as integrated steps in the MDM workflows. Data can be published for a variety of reasons: error records can be published directly to a data steward as part of a data quality workflow, new records can be pushed to consuming applications, and critical updates to the master data can be published to consuming applications.

There are two components to the Publication Node: (1) a design time artifact that captures information about how data should be published in the context of a workflow; and (2) a runtime component, that is the runtime implementation of the Publication Node in the context of the workflow 216.

For the design time component, the Publication Node provides a design-time focal point for specifying the data that should be published, and the manner and format in which it should be published, and it provides a runtime integration point into MDM workflows with the ability to actually publish data as part of a workflow. Accordingly, Publication Node data is defined during the design process, as part of the Workflow 216 definition process, and is stored in the Workflow XML files 216. However, the node data remains in the workflow XML files 216 (which are deployed) and will write a Publication request into a series of RDBMS 106 tables. Since publication processing is initiated from within the RDBMS 106, such node data may need to be accessible via SQL.

The publication node contains all of the actual processing algorithms for pushing data into the specified formats based on metadata definitions. Users (e.g., clients 102) use the Publication Node to specify:
The Publication Object (via its Publication Key)—what data should be published;
Database Mapping—user specifies the source database and table names along with the destination table name (if published to database);
The Publication Method or Action—how should the data be published (e.g., into a spreadsheet format [a file name and optional email addresses], email notification [one or more email addresses], another table, etc.); and
Audit Parameters—user can specify that an audit trail of the Publication should be created, and can specify any parameters (e.g., whether a copy of the published data should also be archived into a Publication Audit Database).

As a new and distinct node type within a workflow, the Publication Node provides a quick and easy means for users to identify a set of data (i.e., the Publication Object) to be published, to specify the manner in which the data will be published (i.e., the Publication Action), and specify any additional Audit parameters. As a processing node, the Publication Node incorporates a set of built-in services to actually perform the processing work that has been specified by the user during the workflow.

For the runtime component, the node is executed as a standard node in an MDM workflow engine. In the design time component, user input is captured and converted directly into the appropriate format. At runtime, a standard task node may publish the data. However, a new node referred to as the Publication Node may still be created in the runtime environment (and used to push MDM-managed data to consumer applications and processes).

In view of the above, it may be seen that the Publication Node is both a design-time focal point for identifying the publication of data, and a runtime process for actually publishing data as part of a Workflow. Such a Publication Node allows the MDM management solution 200 to publish data via workflow 216.

Publication Services Processing

The Publication Services Processing Engine is a central component of the Publication Services feature. Its innovative design pushes as much of the processing as possible into the RDBMS 106, which in turn allows this feature to utilize the power, scalability, and parallelism of an RDBMS 106 to optimize the processing engine. The overall design and architecture of this feature allows it to become a key component of the MDM Workflow Engine. This allows end users to publish master data directly to downstream processes and applications, all within the MDM framework—something that was not previously possible.

The primary architectural goal of the Publishing Services design is to accomplish as much work within the RDBMS 106 (e.g., a data warehouse) as possible. Towards this end, the following will be architectural principles for this feature:
All metadata will be stored in the MDM Operational database (e.g., the RDBMS 106). It may be stored in XML format during design time, but can be deployed to the MDM Operational database. All Publishing Services runtime processing will leverage only metadata that is stored in the MDM operational database (no XML).
SQL will be the first choice to perform the Publishing Services processing.

MDM framework 100 and RDBMS 106 features may be leveraged wherever possible.
Publishing Services work may be performed in the Java™ or XService based code. Such work may occur only when the complete processing cannot be performed via SQL. For example, publishing data in an Excel™ format may require Java/XService based processing to occur.

As described above, FIG. 2 illustrates the structure for how Publishing Services are integrated into the framework 100. The solution 200 provides for Publishing Objects 202 that are used to denote the set of data that should be published, and to assign to this set of data a key (i.e., the Publishing Key). As discussed above, the Publishing Object 202 is simply metadata about the structure of the data being published. In the context of MDM, a Publishing Object 202 may be defined as one or more XDocuments 204, consisting of a ‘primary’ XDocument 204, and zero or more related XDocuments 204. The related XDocuments 204 may have a Foreign Key Relationship (Document Link) back to the Primary Key of the primary XDocument 204.

Essentially, this is stating that a Publication Object 202 will consist of a core or central Table, and 0 or more related tables.

As an example, a Publication Object 202 called “Account” may publish the Account XDocument 204, and may also include the Account_Balance XDocument 204 (as the Account_Balance XDocument 204 would most likely include the primary key of the Account table, and would therefore also contain a Document Link between the two XDocuments 204). It is possible to have an XDocument 204 used in multiple Publication Objects 202. For example:
Publication Object “Customer”
   Includes Customer XDocument
Publication Object “Customer Credit”
   Includes Customer XDocument
   Includes Customer_Credit_Score XDocument

In this example, the XDocument 204 Customer is referenced by multiple Publication Objects 202.

Publication Objects 202 are defined in the context of an XService 206. This means that each XService 206 will contain its own list of Publication Objects 202. Unfortunately, it also means that if multiple XServices 206 need to publish the same information, they will define duplicate Publication Objects 202.

It may be preferable to have a Solution-level set of Publication Objects 202 defined—objects that can be defined one time in one place, and then referenced by each XService 206. However, the problem is that the XService 206 is the key runtime container for all of the processing that takes place. So—in the absence of any higher-level solution or application construct—the Publication Object 202 may need to be defined at the XService 206 level.

One note: the ID of the Publication Object 202 may have to be generated in a design application at design time, and then propagated to the database (e.g., RDBMS 106). The reason for this is that this ID must be known at design time by the Publication Node, so that it can formulate its XRules grammar correctly. The Publication Node will need to add an entry to the Publication Request table that includes this ID, hence the design application may have to generate the ID. The IDs do not need to be sequential, just unique integers, and must be unique within a Solution 200 (not just within an XService 206).

Publication data is stored in two locations. At design-time, Publication Object 202 metadata may be stored locally, in XML files (e.g., in XDocuments 204). The reason for this is that design-time work in a design application may not maintain a direct connection to the database (e.g., RDBMS 106). All information is stored locally on the PC in a series of files and folders, and accessed by the design application as needed.

However, as the Solution 200 is deployed to the runtime environment, the Publication Object 202 metadata will move into the database 106, and will be stored in a series of metadata tables that will reside in the MDM Operational database 208. The actual publication processing 210 may then leverage metadata about the publication objects 202 stored in the MDM Operational Database 208 in order to leverage any RDBMS 106 functionality (e.g., from within the MDM runtime databases 214 including the input, net change, master, and output tables/data). The publication processing 210 may further store the published data or views in the publication database 212.

As described above, publication nodes are a new node type being added to MDM Workflows 216. This node can be inserted at any point in a Workflow 216. The purpose of this node is to signify that a Publication Event needs to occur. Each Publication method will also have a set of specific parameters that need to be specified. Publication nodes are used to specify this additional information. Publication node data is defined during the design process, as part of the workflow definition process and is stored in (and remains in) the Workflow XML files 216. When the publication node is reached during publication processing, it will write a publication request into a series of tables accessible via SQL from the database.

As part the process of publishing Master Data, it may be useful to verify both the Publication Request, and optionally, the Master Data that was published as part of each Publication Request. This allows customers to verify/validate the data associated with each request, and can be used in the future with various compliance requirements that customers may have.

The Publication Audit process is integrated directly into the Publication Services Processing Engine, and may be implemented 100% in the database. This allows the audit process to access the power, scalability, and parallelism of an RDBMS 106 for optimal performance.

One advantage of publication processing is to perform as much of the processing work within the RDBMS 106 as possible. Towards this end, all of the metadata about the publication objects 202 and the publication nodes may be stored in metadata tables that reside in the MDM operational database 208. Accordingly, during the processing of a workflow 216, a publication node is reached (which becomes a Publication Event). When the event occurs, it writes a series of information into the database 106. Thereafter, the remainder of the publishing process is driven by SQL processes.

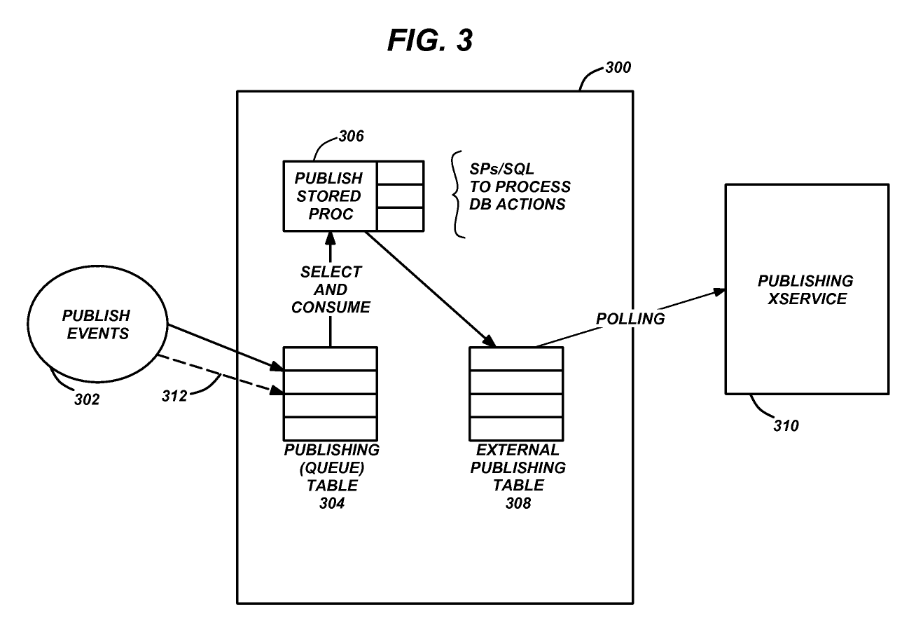

FIG. 3 illustrates publication processing with audit capabilities in accordance with one or more embodiments of the invention. Publication Events 302 trigger the publishing of data. Such Publication Events are written into the Publishing Table 304 (e.g., a Publish Action is added to the Publish Queue Table 304 which controls the publishing flow). The key to the Publishing Table 304 is the Request ID that is used to retrieve any additional information related to the Publication Event (stored in additional tables). Accordingly, the publication node posts a row into the Queue Table 304.

The Publishing Process 300 itself may be initiated via a Stored Procedure 306, that executes a blocking read on the Publishing Table 304. As soon as a new record is detected, it quickly consumes that row (e.g., selects and consumes the row in table 304), and initiates the processing. All processing methods that can be processed via SQL will be handled by this and other Stored Procedures 306. All Audit processes will also be handled 100% by SQL Stored Procedures 306. The stored procedure 306 references the associated metadata from the Publication Object tables to determine the physical tables that will participate in the publishing action. Once found, the subject tables are copied to the physical database which may be named in the metadata. When auditing is enabled, an audit trail for each publishing action is recorded 312 in a set of shadow tables (not shown) to the metadata tables in place to enact audit functionality.

However, there will be some Publication Methods that cannot be addressed via SQL. When this occurs, the request will be moved to a secondary table, called the External Publishing Table 308. Table 308 holds Publication Events that cannot be handled by SQL (e.g., need to be handled via different code such as Java™ code) (e.g., email notifications, publishing data to a spreadsheet such as Excel™, publishing data to a CSV, etc.). The requests in table 308 are executed as part of a new XService 310 called the Publishing Service. This XService 310 is solely responsible for publishing data. It will periodically poll table 308, and will process any events that it detects.

In view of the above, after auditing the request and the data being published, the stored procedure 306 must attempt to handle the publication request. If the data is being published externally (extracted from the database 106), this must actually be handled by external code (e.g., Java™ code). In this case, the stored procedure 106 will move the request into a secondary set of tables 308. From these tables 308, a runtime process 310 will periodically poll the database, checking for these types of publication requests.

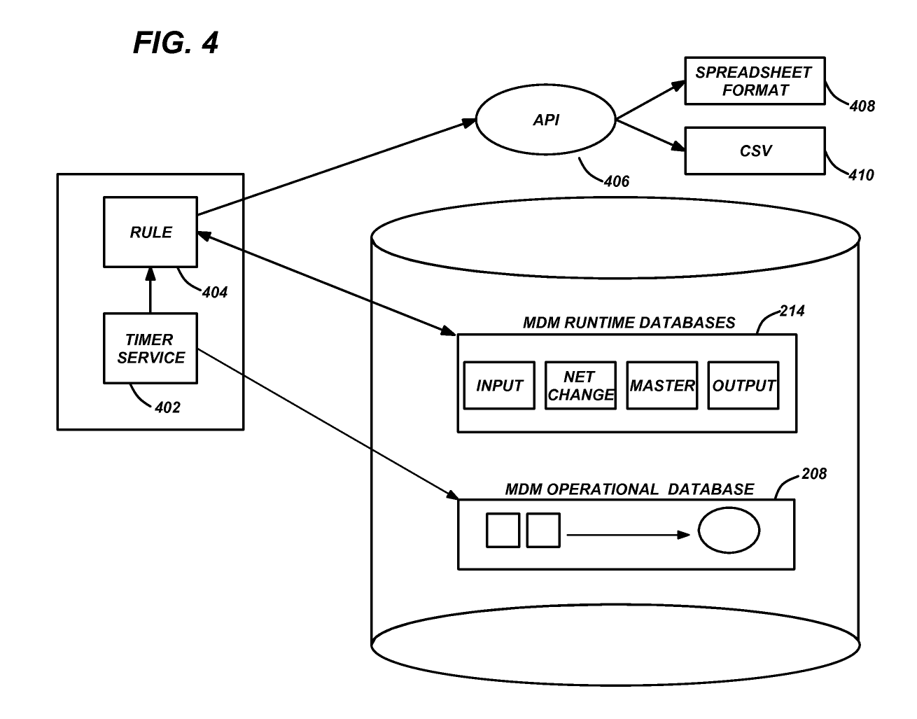

FIG. 4 is a diagram illustrating the processing of publication requests to non-database sources in accordance with one or more embodiments of the invention. The timer service 402 polls the database table 208 for publication requests that go beyond the database 208. If there is a publication request, the timer service 401 passes the request to a rule 404 (e.g., an XML based rule). The rule retrieves the request information from the source table(s) (e.g., the master data table in the runtime database 214), and invokes an API (application programming interface) 406 to publish/convert the data to the appropriate format (e.g., spreadsheet format 408 or CSV [comma separated values] 410). The rule 404 passes the API 406 the service context and the data in an array of results sets.

The Publication Audit process is integrated directly into the Publication Services Processing Engine 300, which in turn is integrated directly into the Workflow Engine of the MDM Framework. The design of this feature allows for both a publication request and its corresponding Master Data to be audited automatically everytime Master Data is published to a downstream consuming application or process. The design of this feature includes not only this integration, but it also includes a 100% SQL based implementation. This implementation can leverage the processing power, scalability, and parallelism of an RDBMS 106 to audit the data in an optimal manner.

Without this integration into the Publication Services Processing Engine, the process of archiving both the publication request and the accompanying Master Data would be either a manual process, or at best, a far less efficient process. Without this solution, it would also be more difficult to integrate this functionality directly into the MDM Workflow Engine, leaving instead as a disjoint process, requiring additional steps in the Workflow to accomplish the same goal.

Logical Flow

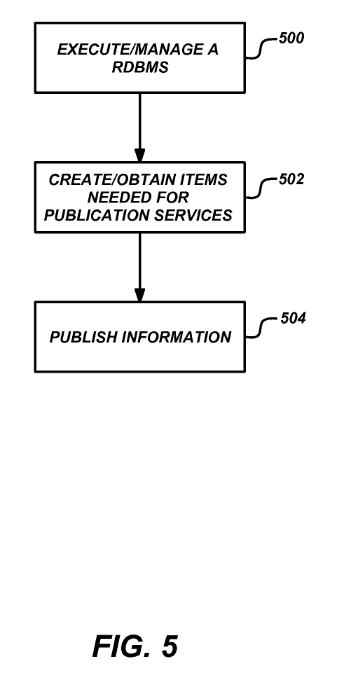

FIG. 5 is a flow chart illustrating the logical flow for publishing information to an external source as part of an integrated workflow in accordance with one or more embodiments of the invention. At step 500, a relational database management system (RDBMS) is executed/managed in a computer system.

At step 502, the items needed/utilized by a publication service are created/obtained. Such items may include a publication object, a publication action, and a publication node. A publication object defines a collection of information that is published to the external source. Such a publication object may further define a composition specification setting forth a composition of the information that is published where the composition specification is in a metadata format. Further, the publication object may provide a linkage (e.g., via a key) of the composition specification to a business context.

A publication action defines a specification of a manner in which the information in the publication object is to be published to the external source. Such a publication action may provide a method specification setting forth a method by which the information will be published (e.g., via email) and a format specification setting forth a format in which the information will be published (e.g., spreadsheet format, text file, set of tables, JMS Provider Queue Tables, etc.).

A publication node is a workflow data process that specifies the publication object, and the publication action. Further, the publication node may optionally (if published to a database) specify a database mapping that maps the information in the RDBMS from a source table to a destination table (e.g., the document name, the source database and source table names, along with the destination/target table names). Additionally, the publication node may further specify audit parameters for creating an audit trail for the publication of the information.

At step 504, the information is published based on the publication node by utilizing the RDBMS via a publication services processing engine executing in the computer system.

### CONCLUSION

This concludes the description of the preferred embodiment of the invention. The following paragraphs describe some alternative embodiments for accomplishing the same invention. In one alternative embodiment, any type of computer or configuration of computers could be used to implement the present invention. In addition, any database management system, decision support system, on-line analytic processing system, or other computer program that performs similar functions could be used with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. An apparatus for publishing information to an external source as part of an integrated workflow in a computer system, comprising:
(a) a relational database management system (RDBMS) executing in the computer system that stores the information;
(b) a publication services processing engine executing in the computer system that is configured to utilize the RDBMS to publish the information based on a publication node;
(c) a publication object stored in the RDBMS and comprising a collection of the information that is published to the external source;
(d) a publication action performed by the publication services processing engine and comprising a specification of a manner in which the information in the publication object is to be published to the external source; and
(e) the publication node comprising a workflow data process performed by the publication services processing engine that specifies the publication object and the publication action.

2. The apparatus of claim 1, wherein the publication object comprises:
a composition specification setting forth a composition of the information that is published, wherein the composition specification is in a metadata format; and
a linkage of the composition specification to a business context.

3. The apparatus of claim 1, wherein the publication action comprises:
a method specification setting forth a method by which the information will be published; and
a format specification setting forth a format in which the information will be published.

4. The apparatus of claim 3, wherein the publication action provides for publishing the information in a spreadsheet format.

5. The apparatus of claim 3, wherein the publication action provides for publishing the information in a text file.

6. The apparatus of claim 3, wherein the publication action provides for publishing the information in a set of tables.

7. The apparatus of claim 3, wherein the publication action provides for publishing the information in JMS™ (Java™ Message Service) Provider Queue tables.

8. The apparatus of claim 3, wherein the publication action provides for publishing the information via email.

9. The apparatus of claim 1, wherein the publication node specifies a database mapping that maps the information in the RDBMS from a source table to a destination table.

10. The apparatus of claim 1, wherein the publication node further specifies audit parameters for creating an audit trail of the publication of the information.

11. A computer-implemented method of publishing information to an external source as part of an integrated workflow in a computer system, comprising:
(a) executing a relational database management system (RDBMS) that stores the information in the computer system;
(b) publishing the information based on a publication node by utilizing the RDBMS via a publication services processing engine executing in the computer system, wherein:
(i) a publication object stored in the RDBMS and comprises a collection of information that is published to the external source;
a publication action performed by the publication services processing engine and comprises a specification of a manner in which the information in the publication object is to be published to the external source; and
(iii) the publication node comprises a workflow data process performed by the publication services processing engine that specifies the publication object and the publication action.

12. The method of claim 11, wherein the publication object comprises:
a composition specification setting forth a composition of the information that is published, wherein the composition specification is in a metadata format; and
a linkage of the composition specification to a business context.

13. The method of claim 11, wherein the publication action comprises:
a method specification setting forth a method by which the information will be published; and
a format specification setting forth a format in which the information will be published.

14. The method of claim 13, wherein the publication action provides for publishing the information in a spreadsheet format.

15. The method of claim 13, wherein the publication action provides for publishing the information in a text file.

16. The method of claim 13, wherein the publication action provides for publishing the information in a set of tables.

17. The method of claim 13, wherein the publication action provides for publishing the information in JMS™ (Java™ Message Service) Provider Queue tables.

18. The method of claim 13, wherein the publication action provides for publishing the information via email.

19. The method of claim 11, wherein the publication node specifies a database mapping that maps the information in the RDBMS from a source table to a destination table.

20. The method of claim 11, wherein the publication node further specifies audit parameters for creating an audit trail of the publication of the information.

21. An article of manufacture comprising a program storage device readable by a computer, tangibly embodying at least one program of instructions executable by the computer to perform method steps of publishing information to an external source as part of an integrated workflow in a computer system, the method steps comprising:
(a) executing a relational database management system (RDBMS) that stores the information in the computer system;
(b) publishing the information based on a publication node by utilizing the RDBMS via a publication services processing engine executing in the computer system, wherein:
(i) a publication object stored in the RDBMS and comprises a collection of information that is published to the external source;
a publication action performed by the publication services processing engine and comprises a specification of a manner in which the information in the publication object is to be published to the external source; and
(iii) the publication node comprises a workflow data process performed by the publication services processing engine that specifies the publication object and the publication action.

22. The article of manufacture of claim 21, wherein the publication object comprises:
a composition specification setting forth a composition of the information that is published, wherein the composition specification is in a metadata format; and
a linkage of the composition specification to a business context.

23. The article of manufacture of claim 21, wherein the publication action comprises:
a method specification setting forth a method by which the information will be published; and
a format specification setting forth a format in which the information will be published.

24. The article of manufacture of claim 23, wherein the publication action provides for publishing the information in a spreadsheet format.

25. The article of manufacture of claim 23, wherein the publication action provides for publishing the information in a text file.

26. The article of manufacture of claim 23, wherein the publication action provides for publishing the information in a set of tables.

27. The article of manufacture of claim 23, wherein the publication action provides for publishing the information in JMS™ (Java™ Message Service) Provider Queue tables.

28. The article of manufacture of claim 23, wherein the publication action provides for publishing the information via email.

29. The article of manufacturer of claim 21, wherein the publication node specifies a database mapping that maps the information in the RDBMS from a source table to a destination table.

30. The article of manufacture of claim 21, wherein the publication node further specifies audit parameters for creating an audit trail of the publication of the information.
